(19) United States
(12) Patent Application Publication
(10) Pub. No.: US 2007/0186177 A1
(43) Pub. Date: Aug. 9, 2007

(54) Content navigation interfaces and associated methods

(75) Inventors: Torsten Both, Tangstedt (DE); Christian Lindholm, Ekenas (FI); Bernd Scheibe, Hamburg (DE); Torsten Schulz, Pinneberg (DE)

Correspondence Address: MORRISON & FOERSTER LLP, 755 PAGE MILL RD, PALO ALTO, CA, 94304-1018, US

(73) Assignee: Yahoo! Inc., Sunnyvale, CA (US)

(21) Appl. No.: 11/502,758

(22) Filed: Aug. 11, 2006

Related U.S. Application Data
(60) Provisional application No. 60/765,224, filed on Feb. 3, 2006.

(51) Int. Cl. G06F 9/00

(52) U.S. Cl. 715/764; 715/835; 715/810; 715/792

(57) ABSTRACT

In one aspect provided herein, a content navigation interface is described. In one example, the content navigation interface includes display logic for displaying a plurality of icons, each icon associated with content (e.g., services, applications, content, etc.). The interface further including selection logic for moving an icon to a selection position in response to user input, and content logic for displaying content associated with the icon in response to the icon being positioned at the selection position. The user may select the icon positioned in the selection position to access or view additional content associated with the icon.

### CROSS-REFERENCE TO RELATED APPLICATION

This application claims benefit of priority to previously filed U.S. provisional patent application Ser. No. 60/765,224 (Attorney docket no. 324213013500), filed Feb. 3, 2006, entitled USER INTERFACE SYSTEMS AND METHODS, and is hereby incorporated by reference as if fully set forth herein.

### BACKGROUND

1. Field

The present invention relates generally to systems and methods for user interfaces, and in one example to a content navigation interface for a device, such as a computer or mobile device.

2. Related Art

A variety of mobile computing devices exist, including, for example, personal digital assistants (PDAs), mobile phones, smart phones, camera phones, pocket personal computers, and the like. Mobile computing devices are performing an ever growing variety of functions, with the trend for mobile computing devices to have increased functionality such that a single mobile device may, for example, provide Internet access via a Web browser, maintain a personal calendar, provide mobile telephony, capture and store digital photographs, play music and video files, and so on. In short, it is generally desired that mobile devices approach or reach the capability and functionality of stand-alone computers (e.g., personal computers).

Generally mobile devices have less capable user input devices (e.g., keyboards, etc.) than stand-alone computers. For example, a mobile device may include a limited alphanumeric keypad, directional buttons, and the like. Further, the display or viewing screen of the mobile device is often of a smaller size to suit the relatively small, compact size of a typical mobile device.

As the number and complexity of applications included with mobile devices increases, the ability for users to navigate content and use various applications and functions may become increasingly difficult, in part, because of the limited user input devices and viewing screens discussed above. Accordingly, it is desired to provide user interface elements and systems that may be used with a mobile device to navigate multiple applications or services, and may further provide improved ease of use of the device.

### SUMMARY OF THE INVENTIONS

According to some aspects of the inventions provided herein, methods and systems for navigating and accessing information on a device (e.g., a mobile computer device, computer, or the like) are provided.

In one aspect provided herein, a content navigation interface is described. In one example, the content navigation interface includes display logic for displaying a plurality of icons, each icon associated with content (e.g., services, applications, content, etc.). The interface further including selection logic for moving an icon to a selection position in response to user input, and content logic for displaying the content associated with the icon in response to the icon positioned at the selection position. The content displayed when the icon is at the selection position may include a content pane including a preview of the content associated with the icon. The user may thereby select the icon positioned in the selection position to access or view additional content associated with the icon.

The interface may further highlight the icon as it is positioned at or moves through the selection position, and the selection positioned may be centered relative to a linear arrangement of icons. In one example, at least a portion of the icons are displayed linearly and may be moved linearly relative to the interface and the selection position. Additionally, as the icons are moved in one direction, icons are removed from the display from one side of the linear arrangement and new icons are displayed on the opposite side (the new icons different or the same as the removed icons). In this fashion, the icons may appear to a user to be rotating in-and-out of the display and through the selection position.

In another aspect, a method for navigating content on user device is provided. In one example, the method includes displaying a plurality of icons, wherein each icon is associated with content, moving the plurality of icons, the icons moving through a selection position, and displaying the content associated with the icon in the selection position. The method may further include selecting the icon at the selection position to display or access additional content.

The icon positioned at the selection position may be highlighted and/or centered relative to other displayed icons. A portion of the displayed icons may be moved relative to the interface the selection position. The icons may be displayed linearly and moved linearly through the selection position. Additionally, as the icons are moved in one direction, icons may be removed from one side of the linear arrangement and new icons displayed on the opposite side (the new icons different or the same as the removed icons).

According to another aspect, a computer program product comprising program code for a content navigation interface is provided. The computer program product may include program code operable for displaying a plurality of icons, wherein each icon is associated with content, moving the plurality of icons, the icons moving through a selection position, and displaying the content associated with the icon in the selection position.

The various aspects and examples of the inventions are better understood upon consideration of the detailed description below in conjunction with the accompanying drawings and claims.

### BRIEF DESCRIPTION OF THE DRAWINGS

FIG. 1 illustrates an exemplary environment in which exemplary devices, systems, and methods described may be used.

FIGS. 2A-2D illustrate an exemplary user interface, and operation thereof, for navigating and accessing content on a device.

FIG. 3 illustrates an exemplary operation of a user interface for navigating and accessing content on a device.

FIGS. 4A-4C illustrate exemplary user interface elements for navigating content.

FIG. 5 illustrates an exemplary method for navigating content on a device.

### DETAILED DESCRIPTION OF THE INVENTIONS

The following description is presented to enable a person of ordinary skill in the art to make and use the inventions. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

In one aspect, a content navigation interface (or a content navigation interface element) is provided, which may be used for navigating and accessing content on or accessible via a user device. In one example, the navigation interface displays multiple icons associated with different content, e.g., applications, services, and/or content such as media objects. The navigation interface moves or “rotates” the plurality of icons through a selection position and is referred to herein as an “icon carousel.” When an icon is positioned at the selection position, content associated with the particular icon is displayed, e.g., in a content pane or window. Accordingly, a user may move or rotate through the icons and view content associated therewith. The selection position may be in the center of the navigation interface and the icons may be highlighted or otherwise identified when in the selection position. A user may select the icon positioned in the selection position to access the content and/or functionality associated with the particular icon.

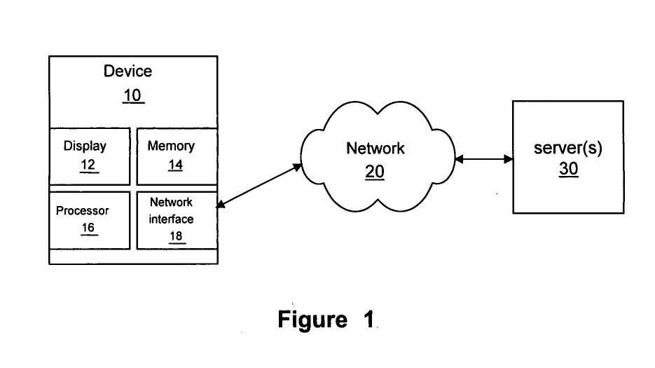

FIG. 1 illustrates an overview of an exemplary environment in which some examples and aspects of a device and content navigation interface described herein may operate and be used. Broadly speaking, a device 10 (including, for example, a mobile computer device) communicates through a network 20 to at least one server 30, which may include account servers (e.g., email servers), mobile servers, and the like. It is noted that an account server, accessible by a user from device 10, may include one or more of a personal email account on an email server (e.g., Yahoo!® Mail), a family photo album account on a photo server (e.g., Yahoo!® Photos), a Personal Information Management (PIM) account on a PIM server (e.g., Yahoo!® Address book or Yahoo!® Notepad), a music library account on a multimedia library server (e.g., Yahoo!® Music), combinations thereof, and the like.

Device 10 may include various hardware, firmware, and/or software, and in particular, a processor 16 connected to an input device such as a keyboard, a network interface 18, a memory 14, and a display 12. Memory 14 (or other portions of device 10) may include logic or software operable with the device to display a content navigation interface and perform some or all of the functions described herein. Device 10 may be operable to include a suitable interface for a messaging facility, such as an email inbox, instant messaging (IM), short messaging service (SMS), multimedia messaging service (MMS), and the like. Device 10 may further be operable to display a web browser for accessing the Internet or user accounts, including webmail environments such as a Yahoo!® mail account or Hotmail® account, for example.

Device 10 may include, for example, a mobile phone, smart phone, Symbian® phone, pocket computer, digital camera, laptop, or handheld personal computer. Device 10 may further include a PIM device such as a Blackberry® or a Treo®, or more dedicated mobile phones that provide more limited information management services. Information management services may include, for example, PIM services such as calendar, address book, tasks, notes, and the like as are generally known.

Device 10 may communicate with one or more servers such as server 30 via network 20, which may include a wireless network, such as a wireless gateway, e.g., a cellular, satellite, or other wireless network. Additionally, device 10 may communicate via a non-wireless network such as a cable or fiber optic network, or a combination of wireless and non-wireless systems.

Network 20 generally includes suitable circuitry for connecting server 30 to network 20, and may be constructed for use with various communication protocols including, but not limited to, TCP/IP, UDP/IP, SMS, IM, and WAP. Network 20 may include or interface with circuitry and components for communicating information, such as email messages, media objects, graphical displays, advertiser data, and the like, over a wired and/or wireless communications medium. Further, network 20 may include or be associated with an SMS center and/or MMS center for transferring files.

Additionally, in one example, a router (not shown) is associated with network 20 and/or one or more servers, e.g., server 30, the router for processing and delivering content between device 10 and server 30. For example, a router may filter data and data structures, parse out data segments, import data, add item IDs to data segments. Additionally, the router may store segments not initially sent to device 10 in a repository (e.g., memory) for later delivery to device 10 and/or delivery to additional content nodes (e.g., other data sinks or data sources). An exemplary router is described, for example, in U.S. patent application Ser. No. 11/264,435, filed Oct. 28, 2005, and entitled “Content Router Core Variants,” the entire content of which is incorporated herein by reference.

Server 30 may include logic or be programmed to format data, accessed from local or remote databases or other sources of data, for presentation to users of device 10, preferably in the format discussed in detail below. Server 30 may include a single device or plural devices, one or more backends, and the like, communicating (wired and/or wireless) and cooperating to perform some or all of the functions described herein. Server 30 may utilize various Web data interface techniques such as Common Gateway Interface (CGI) protocol and associated applications (or “scripts”), Java® “servlets”, i.e., Java applications running on the Web server, or the like to present information and receive input from device 10.

It will be understood by those of ordinary skill in the art that not all the components described may be required, and variations in the arrangement and type of the components may be made without departing from the spirit and scope of the inventions.

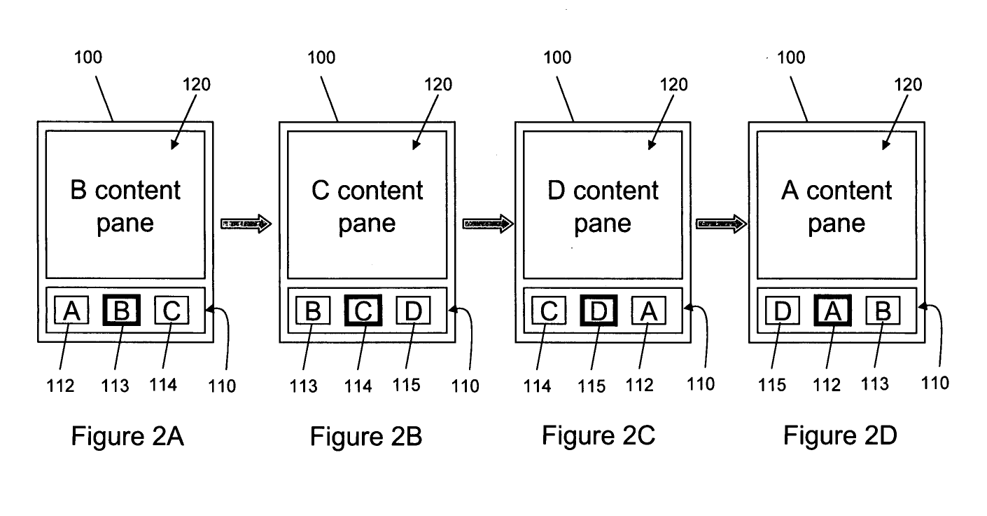

FIGS. 2A-2D illustrate an exemplary user interface 100 for navigating and accessing information on a device. In particular, FIG. 2A illustrates user interface 100 including a content navigation interface element, referred to herein generally as icon carousel 110. Icon carousel 110 is operable to navigate and access content such as applications, services, and content on or accessible by an associated device. User interface 100 and the associated device include or access logic operable to display icon carousel 110, a plurality of icons 112-115, and content associated with the icons, e.g., the services, application, and/or content associated with each icon. Additionally, the user interface 100 and associated device include selection logic for moving the icons 112-115 of icon carousel 110 through a selection position, shown here centered within icon carousel 110, and displaying the associated content when the icon is positioned in the selection position.

In this example, icon carousel 110 includes four icons 112-115, where three of the icons are shown at any given time. Icon carousel 110 is operable to allow a user to “rotate” or move through icons 112-115 as shown by FIGS. 2A-2D. The displayed icons are arranged linearly and are virtually “rotated” in response to user input such that icons move together, e.g., to the left with the leftmost icon being removed and a new icon being added on the right of icon carousel 110. The new icon may include an icon that was not previously displayed, or the icon that was removed from the left. In this fashion, icons 112-115 may appear to a user to be rotating in-and-out of interface 110 and through the selection position.

A user may rotate or move icons 112, 113, and 114 of icon carousel 110, e.g., by using an arrow key or other feature of an input device associated with a particular user device, thereby adding icon 115 to the display of icon carousel 110 and removing icon 113 from the display of icon carousel 110 (as seen in FIG. 2B). Further, the action moves icon 114 to the selection position (e.g., centered within icon carousel 110) and moves icon 113 from the selection position. In this example, the icon positioned at the selection position is highlighted, and remains in one location within icon carousel 110 and interface 100; in particular, centered within icon carousel 110. The icons 112-115 may move within icon carousel 110 in a smooth fashion, e.g., sliding from one position to the next, or may jump from one position to the next. Additionally, a user may rotate icon carousel 110 back to the original icon 113 and may rotate icon carousel 110 in a reverse direction.

Icons 112-115 may be associated with various services and application such as a web browser, email, instant messenger service, photos (e.g., Yahoo!® Photos), weather, news, search, local, sports, finance, entertainment, PIM applications, and the like. As icon carousel 110 is rotated, icons 112-115 are moved through the selection position at the center of icon carousel 110. The user interface 100 includes logic for displaying associated content, in this example, a content pane, in display region 120 for each icon 112-115 such that when successive icons 112-115 are in the selection position, user interface 100 displays a content pane within display 120 associated with that particular icon. The content pane may include a preview of the content associated with a selection of that particular highlighted icon.

As a user rotates icon carousel 110 to highlight one of icons 112-115, it should be understood that icons 112-115 may be highlighted in various fashions, e.g., bolded, enlarged, colored more vividly, different background or border, centered, or the like. Generally, icon carousel 110 or a feature of interface 100 may include identifiable indicia that a particular icon is in a selection position and may be selected without further rotation of icon carousel 110. In another example, the icon is not highlighted, but it will be apparent that the icon is in a selection position because of the presence of its associated content pane being displayed.

The icons described herein may include any user-identifiable image displayed within the content navigation interface, in this example, within icon carousel 110. Further, the icons may be user configurable or configured by the device/application. For example, a device may be initially populated with default icons, such as an icon for mail, instant messenger, web browser, and the like. In other examples, a user may add or configure icons (e.g., by downloading from a server or uploading from another device). For example, a user may add an icon associated with a particular website, application, etc. Additionally, the icon appearance may be changed or altered by the user, e.g., to include a photo image, emoticon, text, and the like.

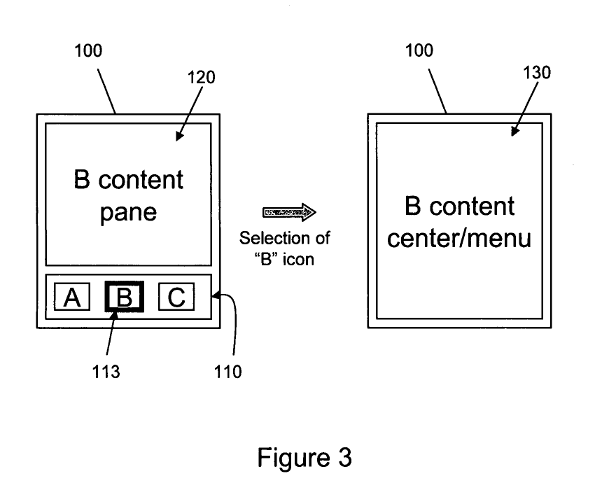

A user may access content associated with the icon in the selection position (and highlighted, for example) of the icon carousel 110 by selecting the icon, e.g., pressing a key, scrolling up, or otherwise indicating a selection (e.g., clicking on the particular icon). Additional content and/or functionality may then be available to the user when selected as shown in FIG. 3. For example, content 130 or a menu of content or options may be displayed when icon 113 is selected. In one example, the icon carousel 110 remains visible to the user as content 130 is displayed. In other examples, the icon carousel 110 may be hidden when icon 113 is selected and content 130 displayed, and the icon carousel 110 may be viewed again, e.g., by an appropriate input via a keypad, “back” function, or the like.

In these examples, icon carousel 110 is illustrated as a horizontal feature at the bottom of user interface 100 having a linear arrangement of icons. A similar icon carousel 110 could be positioned differently, e.g., at the top of the interface 100, be oriented as a vertical feature, or the like.

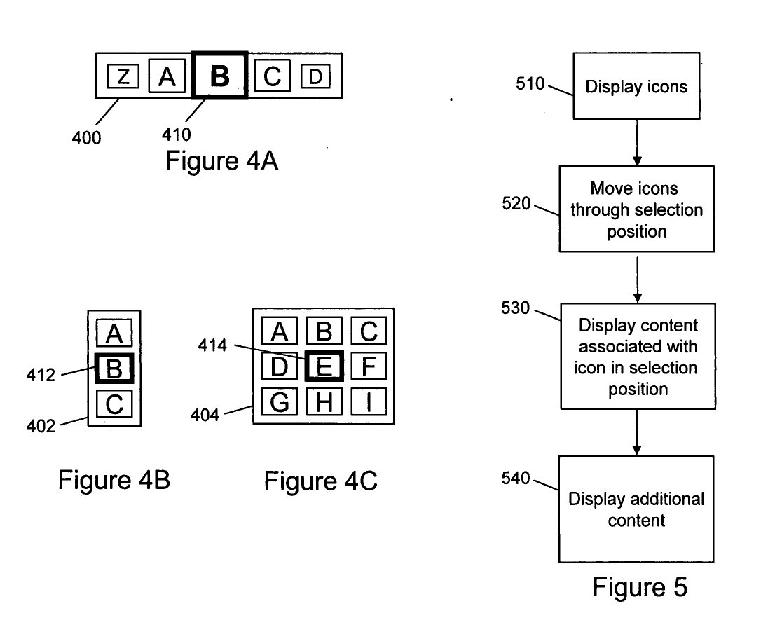

FIGS. 4A-4B illustrate exemplary content navigation interface elements according to other examples. In particular, FIG. 4A illustrates an exemplary icon carousel 400 illustrating five icons “A” through “D” and “Z” arranged linearly, where the icon in the selection position 410 (in this example, centered within carousel 400) is displayed larger in size than non-selected icons. Additionally, more distant icons from the selection positions are displayed progressively smaller. Icon carousel 400 also indicates that more than 5 icons are accessible through icon carousel 400; in particular, a user may rotate icon carousel 400 to navigate and view successive icons “A” through “Z.” It is too be further understood that each icon “A” through “Z” includes a content pane or other content associated therewith that may be displayed when in the selection position and/or selected by a user.

FIG. 4B illustrates an exemplary icon carousel 402 in which icon carousel 402 is oriented vertically. Icon carousel 402 may operate similarly to icon carousel 110 or 400, but with icons capable of moving or rotating up-and-down (as opposed to left-and-right) through a selection position, shown here centered at 412. The icon carousels 400 and 402 shown in FIGS. 4A and 4B may be placed in various locations within a display as described.

FIG. 4C illustrates an exemplary icon carousel 404 which may be moved or rotated both vertically and horizontally, with icons dropping off and being added based on the direction of movement. The selection position 414 is indicated as being in the center of icon carousel, however, in other examples, the selection position 414 could be located in a different location, e.g., a corner, centered in the top row, etc. Thus, various other modifications and variations to the examples described herein will be apparent.

FIG. 5 illustrates an exemplary method for navigating content on or accessible by a user device. A plurality of icons are displayed to a user at 510 with a user interface or user interface element. For example, the icons are displayed within a graphical user interface of a device such as a mobile computer device. The icons may be displayed based on logic included with the device or accessed via a network and server system.

The interface is further operable to move the displayed icons at 520 in response to user input. For example, the icons may be arranged linearly (e.g., horizontally and/or vertically), and movable through a selection position. When icons are moved some of the icons may be removed from the display and additional icons displayed in their place. Further, content associated with an icon positioned at a selection position of the interface is displayed at 530. The content may include, for example, a portion of the content, a preview of the content, or a description of the content. The content may be displayed in a common window, display, etc., or different windows, displays, etc.

In response to a user selecting an icon located at the selection position, additional content is displayed at 540. The additional content may be displayed within the user interface, whether in the same or a different window or panel of the user interface. In other examples, an action or function may take place upon selection, e.g., accessing the phone or voicemail functions of the device.

The various aspects and examples of the inventions can be implemented in any suitable form including hardware, software, firmware or any combination of these. Different aspects of the invention may be implemented at least partly as computer software or firmware running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A content navigation interface apparatus, comprising:
display logic for displaying a plurality of icons, each icon associated with content;
selection logic for moving an icon to a selection position in response to user input; and
content logic for displaying the content associated with the icon in response to the icon positioned at the selection position.

2. The apparatus of claim 1, further comprising logic for highlighting the icon positioned at the selection position.

3. The apparatus of claim 1, wherein the selection position is centered relative to the displayed icons.

4. The apparatus of claim 1, the display logic further for displaying the icons within a window and the selection logic further for moving the icons relative to an interface window and the selection position.

5. The apparatus of claim 1, the display logic further for displaying at least a portion of the plurality of icons linearly, and the selection logic for moving the icons linearly relative to the selection position in response to user input.

6. The apparatus of claim 5, further comprising logic for removing a first icon from a first end of the linearly displayed icons and adding a second icon to an opposite second end of the linearly displayed icons in response to moving the icons.

7. The apparatus of claim 6, wherein the first icon and second icon are different.

8. The apparatus of claim 1, wherein the content comprises a content pane.

9. The apparatus of claim 1, further comprising logic for displaying additional content associated with the icon in response to selection of the icon at the selection position.

10. A method for navigating content on a user device, the method comprising:
displaying a plurality of icons, wherein each icon is associated with content;
moving the plurality of icons, the icons moving through a selection position; and
displaying the content associated with the icon when in the selection position.

11. The method of claim 10, further comprising highlighting the icon positioned at the selection position.

12. The method of claim 10, wherein the selection position is centered relative to the displayed icons.

13. The method of claim 10, further comprising displaying the icons within a window and moving at least a portion of the icons relative to an interface window and the selection position.

14. The method of claim 10, further comprising displaying at least a portion of the plurality of icons linearly, and moving the icons linearly relative to the selection position in response to user input.

15. The method of claim 14, further comprising logic for removing a first icon from a first end of the linearly displayed icons and adding a second icon to an opposite second end of the linearly displayed icons in response to moving the icons.

16. The method of claim 15, wherein the first icon and second icon are different.

17. The method of claim 10, further comprising displaying additional content associated with the icon in response to selection of the icon at the selection position.

18. A computer program product comprising program code for navigating content, the computer program product comprising program code for:
displaying a plurality of icons, wherein each icon is associated with content;
moving the plurality of icons, the icons moving through a selection position; and
displaying the content associated with the icon in the selection position.

19. The computer program product code of claim 18, further comprising program code for highlighting the icon positioned at the selection position.

20. The computer program product code of claim 18, wherein the selection position is centered relative to the displayed icons.

21. The computer program product code of claim 18, further comprising program code for displaying the icons within a window and moving at least a portion of the icons relative to an interface window and the selection position.

22. The computer program product code of claim 18, further comprising program code for displaying at least a portion of the plurality of icons linearly, and moving the icons linearly relative to the selection position in response to user input.

23. The computer program product code of claim 22, further comprising program code for removing a first icon from a first end of the linearly displayed icons and adding a second icon to an opposite second end of the linearly displayed icons in response to moving the icons.

24. The computer program product code of claim 23, wherein the first icon and second icon are different.

25. The computer program product code of claim 18, further comprising program code for displaying additional content associated with the icon in response to selection of the icon at the selection position.
